(19) United States
(12) Patent Application Publication
(10) Pub. No.: US 2023/0010095 A1
(43) Pub. Date: Jan. 12, 2023

(54) METHODS FOR CASCADE FEDERATED LEARNING FOR TELECOMMUNICATIONS NETWORK PERFORMANCE AND RELATED APPARATUS

(71) Applicant: Telefonaktiebolaget LM Ericsson (publ), Stockholm (SE)

(72) Inventors: Abdulrahman ALABBASI, KISTA (SE); Tony LARSSON, UPPLANDS VÄSBY (SE); Konstantinos VANDIKAS, SOLNA (SE); Omer HALILOGLU, ISTANBUL (TR)

(21) Appl. No.: 17/784,570

(22) PCT Filed: Dec. 18, 2019
(86) PCT No.: PCT/EP2019/086065

§ 371 Date: Jun. 10, 2022

(51) Int. Cl. H04L 41/14; H04L 41/147; H04L 41/16

(52) U.S. Cl. CPC H04L 41/145; H04L 41/147; H04L 41/16

(57) ABSTRACT

A method performed by a network computing device in a telecommunications network for adaptively deploying an aggregated machine learning model and an output parameter in the telecommunications network to control an operation in the telecommunications network. The network computing device can aggregate client machine learning models and an output performance metric the client machine learning models to obtain an aggregated machine learning model and an aggregated output performance metric. The network computing device can train a network machine learning model with the aggregated output performance metric and at least one measurement of a network parameter to obtain an output parameter. The network computing device can send to the client computing devices the aggregated machine learning model and the output parameter of the network machine learning model. A method performed by a client computing device is also provided.

### TECHNICAL FIELD

The present disclosure relates generally to methods and apparatus for cascaded federated learning for performance in a telecommunications network.

### BACKGROUND

Decisions, for example, related to secondary carrier handover or selection process in a telecommunications network is currently taken at the network side, where a communication device (e.g., a user equipment (UE)) reports different measurements based on network requests or periodic allocation. The periodicity of such measurements requests from UE might vary from tens of milliseconds to more than hundreds of milliseconds.

From a machine learning (ML) perspective, federated learning presently may be a machine learning tool that competes with other approaches for ML models that may train on large aggregations of data collected over multiple data sources. As referred to in this disclosure, such ML models are referred to as “centralized machine learning models”.

FIG. 1 illustrates an approach to Federated Learning (FL). As shown in Error! Reference source not found., FL includes: Client devices (e.g. UEs) 105 that train on only local data and do not share this data with any other devices (e.g, base station 101, UEs 105), and servers (e.g. a base stations or g Node B (gNB) 101) that combine clients' ML models 107.

Generally, FL follows operations illustrated in FIG. 1. Each client 105 (e.g., 105a-105e) may train its ML model 107 (e.g., 107a-107e, respectively) on local data. Each client 105 may upload its trained ML model (107), but not the client's data, to a gNB 101. gNB 101 may combine the clients' 105 ML models 107 to obtain a combined ML model 103. gNB 101 may send the combined ML model 103 to each of the clients 105. Iteration may be performed over these operations until convergence (e.g., an output of the combined ML model 103 is or approaches a defined value).

### SUMMARY

According to some embodiments, a method performed by a network computer device in a telecommunications network is provided for adaptively deploying an aggregated machine learning model and an output parameter in the telecommunications network to control an operation in the telecommunications network. The network computing device can perform operations aggregating a plurality of client machine learning models received from a plurality of client computing devices in the telecommunications network to obtain an aggregated machine learning model. The network computing device can perform further operations aggregating an output performance metric of the plurality of the client machine learning models received from the plurality of client computing devices to obtain an aggregated output performance metric. The network computing device can perform further operations training a network machine learning model with inputs including 1) the aggregated output performance metric and 2) at least one measurement of a network parameter to obtain an output parameter of the network machine learning model. The network computing device can perform further operations sending to the plurality of client computing devices the aggregated machine learning model and the output parameter of the network machine learning model.

Corresponding embodiments of inventive concepts for network computing devices, computer products, and computer programs are also provided.

According to some embodiments, a method performed by a client computing device in a telecommunications network is provided to control an operation in the telecommunications network. The client computing device can perform operations receiving an aggregated machine learning model from a network computing device. The client computing device can perform further operations receiving an output parameter of a network machine learning model from the network computing device. The client computing device can perform further operations training the aggregated machine learning model in iterations with inputs. The inputs include 1) the output parameter and 2) at least a location or at least one measurement of the client computing device to obtain an output performance metric of the aggregated machine learning model. The client computing device can perform further operations sending the output performance metric of the aggregated machine learning model to the network computing device at each iteration of the training or at the last iteration of the training.

Corresponding embodiments of inventive concepts for client computing devices, computer products, and computer programs are also provided.

Other systems, computer program products, and methods according to embodiments will be or become apparent to one with skill in the art upon review of the following drawings and detailed description. It is intended that all such additional systems, computer program products, and methods be included within this description and protected by the accompanying embodiments.

The following explanation of potential problems is a present realization as part of the present disclosure and is not to be construed as previously known by others. Some approaches for improving telecommunications (mobile) network performance, e.g. secondary carrier prediction, may not use machine learning. Thus, without a deployed machine learning agent, the network and a UE may not be able to predict parameters for controlling an operation in the network.

Another possible approach may use centralized machine learning at the network side. Centralized machine learning, however, may use significant signaling and measurement reporting in a training phase; and may not have UE features that help in predictions due to privacy or other issues. Thus, centralized machine learning may ignore UE input to predict parameters for controlling an operation in the network.

Another possible approach may use federated learning. Federated learning, however, may be limited to features of the client devices, and incorporation of features of client devices and a gNB may not be possible.

Thus, improved processes for predicting parameters for controlling an operation in a telecommunications network are needed.

One or more embodiments of the present disclosure may include methods for deploying an aggregated machine learning model and an output parameter in a telecommunications network to control an operation in the telecommunications network (also referred to herein as a network). The methods may include a network computing device that uses a cascaded and hybrid federated model to adaptively enable client computing devices (e.g., UEs) to participate in heterogeneously taking a decision on an operation in the network. Operations advantages that may be provided by one or more embodiments include preserving privacy of the UE's information (e.g., a UE's private information, such as location, may not be shared), and measurements and features at both UEs and a network computing device (e.g., a gNB) may be used. Thus, one or more embodiments may improve a parameter in the network and an associated decision for controlling that parameter.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates an approach to federated learning;

FIG. 2 illustrates a telecommunications network communicatively connected to network computing device according to some embodiments of the present disclosure;

FIG. 3 a network machine learning model according to some embodiments of the present disclosure;

FIG. 4 illustrates a client machine learning model according to some embodiments of the present disclosure;

FIG. 5 illustrates elements of the neural network circuit which are interconnected and configured to operate in accordance with some embodiments of the present;

FIG. 6 is a block diagram and data flow diagram of a neural network circuit that can be used in the network computing device according to some embodiments of the present disclosure;

FIG. 7 is a block diagram illustrating a client computing device according to some embodiments of the present disclosure;

FIG. 8 is a block diagram illustrating a network computing device according to some embodiments of the present disclosure;

FIG. 9 is a block diagram illustrating a controller network computing device according to some embodiments of the present disclosure;

FIG. 10 illustrates elements of the neural network circuit which are interconnected and configured to operate in accordance with some embodiments of the present disclosure;

FIG. 11 is a block diagram and data flow diagram of a neural network circuit that can be used in a client computing device in accordance with some embodiments of the present disclosure;

FIGS. 12-25 are flowcharts illustrating operations that may be performed by a network computing device in accordance with some embodiments of the present disclosure; and

FIGS. 26-32 are flowcharts illustrating operations that may be performed by a client computing device in accordance with some embodiments of the present disclosure.

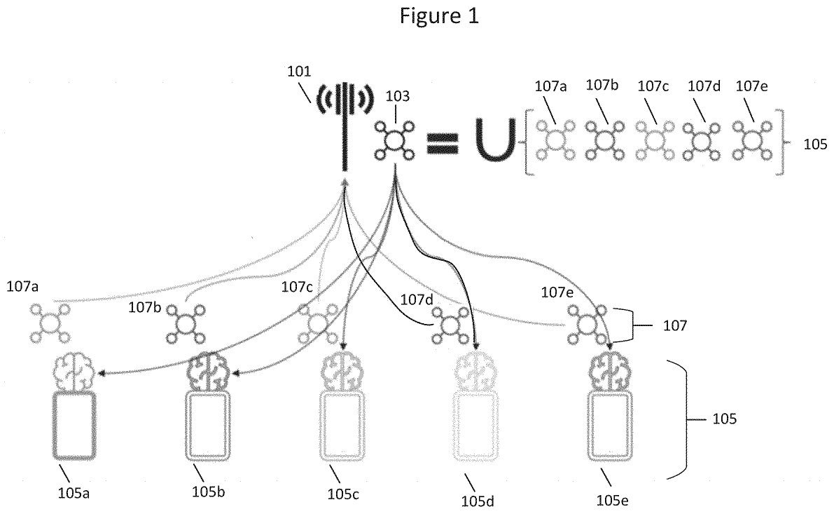

### DETAILED DESCRIPTION

Various embodiments will be described more fully hereinafter with reference to the accompanying drawings. Other embodiments may take many different forms and should not be construed as limited to the embodiments set forth herein; rather, these embodiments are provided by way of example to convey the scope of the subject matter to those skilled in the art. Like numbers refer to like elements throughout the detailed description.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, a client computing device refers to any device intended for accessing services via an access network and configured to communicate over the access network. For instance, the client computing device may be, but is not limited to: a user equipment (UE), a communication device, mobile phone, smart phone, sensor device, meter, vehicle, household appliance, medical appliance, media player, camera, or any type of consumer electronic, for instance, but not limited to, television, radio, lighting arrangement, tablet computer, laptop, or PC. The client computing device may be a portable, pocket-storable, hand-held, computer-comprised, or vehicle-mounted mobile device, enabled to communicate voice and/or data, via a wireless or wireline connection.

As used herein, network computing device refers to equipment capable, configured, arranged and/or operable to communicate directly or indirectly with a client computing device and/or with other network nodes or equipment in the radio communication network to enable and/or provide wireless access to the user device and/or to perform other functions (e.g., administration) in the radio communication network. Examples of network nodes include, but are not limited to, base stations (BSs) (e.g., radio base stations, Node Bs, evolved Node Bs (eNBs), gNode Bs (including, e.g., network computing node 201, etc.), access points (APs) (e.g., radio access points), servers, etc. Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node. More generally, however, network nodes may represent any suitable device (or group of devices) capable, configured, arranged, and/or operable to enable and/or provide a user device with access to the telecommunications network or to provide some service to a user device that has accessed the telecommunications network.

Some approaches for federated learning may provide advantages in a wireless network. Possible advantages may include that federated learning may provide improvements to mobile network (e.g, a 5G) network in terms of preserving UE information privacy. For example, a UE may not send the UE's position to a gNB, and may use a learning model instead. Additional potential advantages may include an exchange of learning among UEs, enabling more efficient signaling for a gNB and UEs (e.g., reduce signaling), and decreasing data transfer since information that is exchanged between UEs and a gNB may be compressed by way of a neural network.

Potential problems with some approaches may be categorized depending on the type of approach as described below.

Potential problems related to deployed systems in a network without federated learning may include the following.

In some systems, no machine learning agent is deployed in a system. Accordingly, network equipment (e.g., a gNB) or UE cannot predict a parameter (e.g., the reference signal receive power (RSRP)/reference signal received quality (RSRQ)) without machine learning or a statistical prediction algorithm; and only UE measurement and reporting of RSRP/RSRP may be relied on. Thus, decisions may be delayed (e.g., secondary carrier handover, carrier aggregation selection, dual connectivity selection decisions).

In other systems, a centralized machine learning approach may be deployed at the network side. In such an approach, a network may try to predict a parameter (e.g., signal strengths) at the UE side. This approach, however, may cause potential problems including: 1) large signaling and measurement reporting at a training phase. Large signaling may increase if the model is an online mode, where training phase is carried frequently, because supervised learning at the network side may require reporting a measurement (e.g. RSRP) from the UE side. 2) Missing UE features that may help in prediction (e.g., UE location that is missing due to privacy or other issues). Thus, this approach may ignore UE input to control an operation in the network (e.g., secondary carrier handover like decision).

Potential problems related to applying some approaches for federated learning to a wireless network may include the following.

Some approaches to federated learning may be limited to the features of the clients (e.g., UEs), whereas a server (e.g., gNB) may have much more features that may help for improving network performance that depends on decisions (e.g., secondary carrier decisions, such as decisions on hand over, dual connectivity, carrier aggregation, RLC legs, duplications, milli-meter wave communication).

Additional potential problems with some approaches to federated learning may include that incorporation of features of both clients and servers (e.g., a gNB) may not be possible. Thus, utilizing heterogeneous information at both a gNB and UEs may not be possible (e.g., utilizing clients' features (e.g., location information of UEs) and server's features (e.g., throughput, load, interference information from gNB), together may not be possible).

In various embodiments of the present disclosure, a parameter may be predicted and related decisions on the parameter may be made to control an operation in the telecommunications network. A cascaded and hybrid federated model may be used to enable the telecommunications network to adaptively enable UEs to participate in taking (heterogeneously) a decision on n operation in the telecommunications network, while preserving the privacy of the UE's information (e.g., not sharing the UE's private information such as location).

In various embodiments of the present disclosure, a method may be provided for secondary carrier prediction and related decisions on secondary carrier operations (such as selection, handover, dual connectivity, etc). A cascaded and hybrid federated model may be included that enables a network to adaptively enable UEs to participate in taking (heterogeneously) a decision on secondary carrier operations, while preserving the privacy of the UEs' information (e.g., UEs' private information such as location may not be shared). The methods may take advantage of measurements and features at both UEs (e.g., location, etc) and a gNB (e.g., throughput, load, interference, etc.) sides. Thus, the methods may improve, e.g, secondary carrier (SC) strength and an associated decision. The methods may further provide sever messaging and methods for exchanging training and/or operation related information.

In various embodiments of the present disclosure, a method is provided in a telecommunications network for adaptively deploying an aggregated machine learning model and an output parameter in the telecommunications network to control an operation in the telecommunications network. One exemplary application is for secondary carrier prediction and a related decision(s) on secondary carrier operations (such as selection, handover, dual connectivity, etc.).

Presently disclosed embodiments may provide potential advantages. One potential advantage may provide for a greater degree of freedom when a model is learning (e.g., learning not only from UEs but also from a network node). Another potential may provide new input to local training that may be obtained from a network node model output, and flexibility in taking decisions related to controlling an operation in the telecommunications network.

Further potential advantages of various presently disclosed embodiments may include improving learning performance, parameter prediction (e.g., secondary carrier prediction), and a decision on the predicted parameter (e.g. improving carrier selection).

Further potential advantages of various presently disclosed embodiments may include improving federated learning performance (loss or accuracy), and improving parameter prediction (e.g., secondary carrier prediction). These potential improvements may be provided due to, for example, interference (and other cells' based measurement in the network) may be directly or indirectly related to secondary carrier strength (e.g., RSRQ or RSRP). Thus, knowing such a parameter, may result in a more accurate training of the ML mode.

Further potential advantages of various presently disclosed embodiments may include improving carrier selection (e.g., at dual connectivity, carrier aggregation, moving to mm-Wave, etc.) or handover process. These potential improvements may be provided due to, for example, interference (and other cells' based measurement in the network) may be directly or indirectly related to secondary carrier strength (e.g., RSRQ or RSRP). Thus, knowing such a parameter, may result in a more accurate training of the ML mode. Additionally, a cell-based parameter, may help the decision making process of selecting a new carrier (e.g., the decision may not be only related to carrier prediction, but also the prediction of future selected carriers based on parameter other than strength).

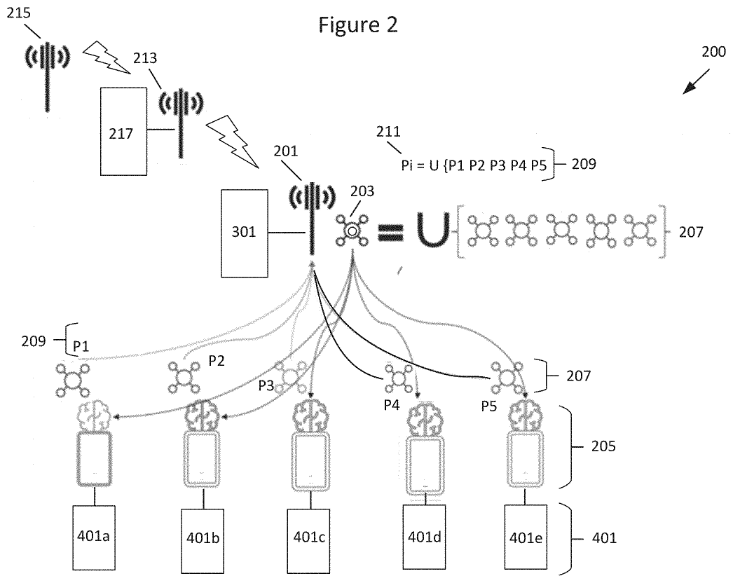

FIG. 2 illustrates a telecommunications network 200 communicatively connected to network computing device 201 according to some embodiments of the present disclosure.

Referring to FIG. 2, in various embodiments of the present disclosure, a network computing device 201 may include, but is not limited to, a server, a base station, a gNB, etc. Client computing devices 205 may include, but are not limited to, UEs, mobile devices, wireless devices, etc. The terms “client computing device”, “user equipment (UE)”, and “communication device” are used interchangeably herein. The network computing device 201 may include, be communicatively coupled to, a cascaded federated learning model that includes a federated learning model 203 and a network machine learning model 301. The terms “network computing device”, “g Node B (gNB)”, “base station”, and “server” are used interchangeably herein.

The network computing device 201 and client computing devices 205 of FIG. 2 are an example that has been provided for ease of illustration and explanation of one embodiment. Other embodiments may include any non-zero number of network computing devices and client computing devices.

UEs 205 may upload to gNB 201 (a) their ML models 207 (also referred to herein as client machine learning models 207), and (b) quantized version of their output or a function of that output 209 (e.g., P1-P5) (also referred to herein as output performance metric 209). gNB 201 may aggregate a) UEs' 205 ML models 207, and b) UEs' 205 quantized output 209 (e.g., secondary carrier signal strength (RSRP, RSRQ, etc.).

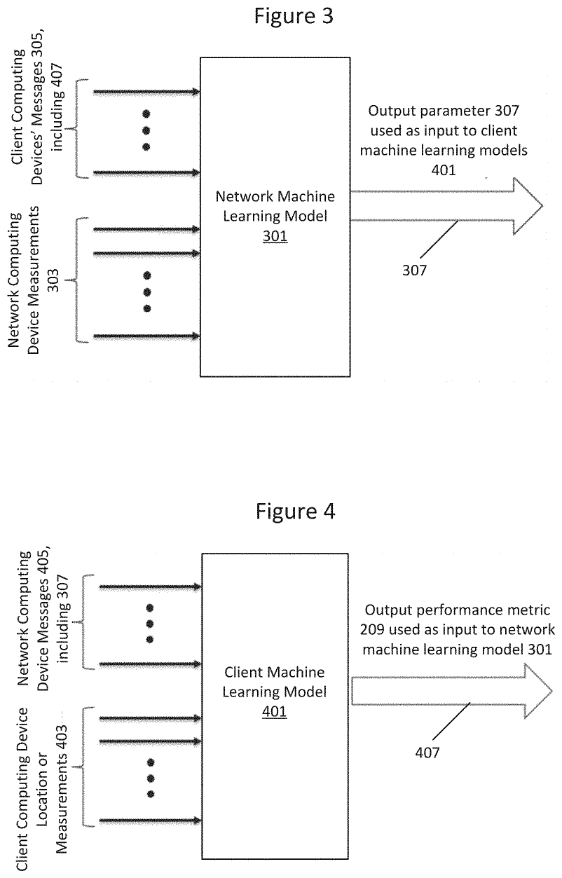

gNB 201 may take (a) the aggregated quantized output, mean squared error (MSE) or coefficient of determination (R2) 211 (also referred to herein as aggregated output performance metric 211), and (b) other gNB 201 available measurement(s) such as network throughput, load, and interference (also referred to herein as measurement of a network parameter 303), and use the aggregated output 211 and measurement(s) 303 to train a centralized, or other type of model, at gNB 201 (also referred to herein as a hybrid server model 301 or a network machine learning model 301), as described below with reference to FIG. 3.

gNB 201 may download to UEs 205 (a) the aggregated UEs' model 203, and (b) a quantized output, MSEs, or R2s 307 (also referred to herein as output parameter 307) (not shown in FIG. 2) of the gNB 201 centralized model 301. UEs 205 may consider the aggregated UEs' model 203 and the quantized output, MSEs, or R2s 307 as updates, in addition to gNB's 201 own location and measurement, to iterate and train local model 301 of gNB 201, as described further below with reference to FIG. 3.

After UEs 205 predict, e.g., secondary carrier (SC) strength (e.g. RSRP/RSRQ), a decision on SC operations (e.g., handover or selection) may be taken and may include:

A UE 205 may take a final decision on SC handover or selection based on trained model 401 (as described further below with reference to FIG. 4), and (1) act on the decision (e.g., continue SC handover or selection procedures), or (2) send the decision to the network (e.g., gNB 201) and the network will act on the decision (e.g., continue the SC handover or selection procedures).

Alternatively, a UE 205 may send a confidence value (e.g., a probability) of its decision, e.g. on SC handover or selection, to the network (e.g., gNB 201). The network (e.g. gNB 201) may generate a discrete report and take final decision.

Alternatively, gNB 201 may take a final decision on SC handover or selection based on the quantized report of the predicted SC.

Still referring to FIG. 2, in some embodiments, operations of network computing device 201 (e.g., a server 201) may include the following. Server 201 may aggregate the clients' 205 models to obtain an aggregated machine learning model 203. Further operations of server 201 may include training a network machine learning model 301 at server 201. Server 201 may download (e.g., downlink): (1) quantized output, MSEs, or R2s 307 of the network machine learning model 301, either at each iteration or at a last iteration and (2) the Aggregated machine learning model 203. Further operations may include that the server 201 may (a) fully or (b) partially take the decision on SC handover or selection based on: (1) the model 301 of server 201 and the quantized UE output 211, or (2) the model 301 and a UE 205 decision based on confidence interval. In the second approach, server 201 may combine its decision with the UE 205 decision in an optimal manager, for example, averaging or statistical methods, etc.

Still referring to FIG. 2, in some embodiments, operations of client computing devices 205 (e.g., UEs 205) may include the following. UEs 205 may train their model 207 as described further below with reference to FIG. 4. Further operations may include UEs 205 uploading (1) the models 207 of UEs 205, for example, weights and biases; and (2) quantized outputs, MSEs, or R2s 209, either at each iteration or at a last iteration. Further operations may include UEs 205 may take (a) full or (b) partial decision on SC handover or selection based on its model, (c) or take no decision at all (e.g., prediction of SC RSRP/RSRQ and leave the decision to gNB 201).

In the first approach, a UE 205 may have to take its decision on SC handover or selection, and then send the decision to gNB 201 via a resource radio control (RRC), medium access control (MAC), or physical PHY message.

In the second approach, a UE 205 may have to take its decision on SC handover or selection, and then convert the decision to a confidence value (e.g., probability based) and send the value to gNB 201 via RRC, MAC, or PHY messages.

In the third approach, a UE 205 may not take a decision on SC handover or selection. UE 205 may send its predicted SC value to gNB 201 via RRC, MAC, or PHY messages.

FIG. 3 illustrates a network machine learning model 301 with inputs including: 1) network computing device 201 measurements 303, and 2) client computing devices 205 messages 305, which may include output 407 of client machine learning model 401. Output 307 of network machine learning model 301 may include output parameter 307.

FIG. 4 illustrates a client machine learning model 401 with inputs: 1) client computing devices 205 location or messages 403, and 2) network computing device 201 messages 405, which may include output 307 of network machine learning model 301. Output 407 of client machine learning model 401 may include output performance metric 209.

In some embodiments, the exchange of quantized outputs, quantized MSE or R2 307 and 407 of both client computing devices 205 or network computing device 201 (e.g., UE or gNB, respectively) models might differ depending on the dynamicity of the wireless environment, network measurement (e.g., throughput, load, and interference), and client computing device 205 location. For example, a UE 205 might send to gNB 201 (during the iteration phase) only the model 207 or both the quantized output (or MSE or R2) 209 and the model 207. Further, gNB 201 might send to UEs 205 (during the iteration phase) only the aggregated model 203 or both the gNB output (quantized output or MSE or R2) 307 and the aggregated model 203.

In some embodiments, input to the network machine learning model 301 model that is obtained from a UE 205 may be adapted to the number of reporting or active UEs 205. For example, gNB 201 takes a weighted average of all UEs' 205 reported output as input; gNB 201 statistically combines all UEs' 205 output to be considered as input; or gNB 201 takes a minimum or a maximum of all UEs' 205 output to be considered as input, etc.

In some embodiments, gNB 201 and a UE 205 exchange local model 207 of UE 205 and aggregated model 203 via RRC configurations signals; physical downlink control channel (PDCCH) and physical uplink control channel (PUCCH) signals; and/or medium access control (MAC) control element (CE) signals.

In some embodiment, gNB 201 and UE 205 exchange the quantized output 209 of UE 205 and centralized quantized 307 output via RRC configurations signals; PDCCH and PUCCH signals; and/or MAC CE signals.

In some embodiment, the network may change and mix the signaling methodology (of both models and quantized MSE or R2/outputs) depending on convergence speed, dynamicity of the wireless channel, required accuracy, mobility (change of UE location), etc. For example, when a fast and small size model and input update is needed, the network may enable PHY layer model transfer with mini-slot. This may enable that the information needed to be transferred arrives without a time limit.

In some embodiments, the network dynamically decides on whether (1) gNB 201 only learns and predicts secondary carrier strength, or (2) conventional federated learning, or 3) cascaded federated learning is used to enhance the secondary carrier prediction and selection. The dynamic decision may be based on changes of wireless fading channel, network load, interference from neighbor cells or networks, etc. It is also may be based on (a) whether UE 205 local information is enough to make the prediction, (b) gNB 201 measurement is enough to make the prediction, (c) or both are needed. Once the above decision is made, gNB 201 can communicate a specific signal to UE 205, upon reception of which, UEs 205 will understand the gNB 201 intention.

In some embodiments, the network may utilize the UE 205 shared model 207 and quantized MSE or R2 209 to make a proactive decision on the secondary carrier application, such as selecting the suitable secondary carrier for dual connectivity or carrier aggregation, etc.

Various embodiments of the present disclosure may provide several technical enhancements compared to some approaches of federated learning. For example, RSRQ/RSRP may depend on gNB based information (interference, load, throughput (TP), etc.), Thus, including extra information in accordance with various embodiments may enhance the accuracy and convergence rate of the prediction. Additional potential technical enhancements may include, for example, that load and TP of neighbor cells may be used in the process of secondary carrier selection, not only the accuracy of the predicted secondary carrier strength.

Various operational phases will now be described.

In some embodiments, in a training phase, network computing device 201 decides on an operation mode among the following modes: (1) gNB 201 takes full decision on SC operations (handover or selection, etc.); (2) gNB 201 and UE 205 participate in decision making for SC operations; and (3) UE 205 takes full decision on SC operation. Both UEs 205 and gNB 201 iterate on their perspective model, as described above, until UEs 205 and gNB 201 reach the desired accuracy of predicted secondary carrier RSRP/RSRQ.

In some embodiments, in an execution phase, both UE 205 and gNB 201 follow the decided operation mode. UEs 205 predict SC RSRP/RSRP, every decided T period of time. The period of time, T, may depend on the dynamicity of changes in the wireless environment, UE 205 location, and the needed speed of convergence. Based on the selected operation mode and the predicted values of SC, UE 205 may exchange the associated information (to the operation mode) to gNB 201. Additionally, based on the selected operation mode, gNB 201 may process the information uploaded by UEs 205 to gNB 201 as described above.

Exemplary inputs to models 301 and 401 of various embodiments will now be described.

Inputs to the client machine learning model 401 may include, but are not limited to, UE 205 location (altitude and longitude); gNB 201 model's quantized output, MSE or R2; Time; Surrounding event; Etc.

Inputs to the network machine learning model 301 may include, but are not limited to: Network throughput and load; Cell throughput and load; Neighbor interference; UE 205 quantized output, MSE, or R2; Etc.

Exemplary outputs of models 301 and 401 of various embodiments will now be described.

Outputs of network machine learning model 301 may include, but is not limited to: Aggregated clients' local model 203 weights; Gradient with respect to common features between client 205 and server 201; Loss value; Etc.

Outputs of client machine learning model 401 may include, but is not limited to: RSRP; RSRQ; selection decision; Local gradients with respect to common features between client 205 and server 201; Local loss value; Etc.

Online updating of models 301 and 401 will now be described.

In various embodiments, network computing device 201 chooses to continue updating the UEs model 401 even while running the execution phase depending on, for example environmental changes, neighbor events, a surrounding event(s), etc ; channel fluctuation; fluctuation on loads on target and neighbor cells, etc.

In a training phase, there may not be stringent constraints on updating the models, due to flexible time and bandwidth. However, when operating in execution mode, cells may be fully loaded, and decision on e.g. secondary carrier (or handover to another serving cell) should be made very fast, with stringent latency on model convergence. Thus, in some embodiments, a model is updated depending on the situation. For example, if a quick and large size model update is needed, network computing device 201 may enable an all layer's model transfer mode, e.g, PHY, MAC, radio link control (RLC), packet data convergence protocol (PDCP), and Application layers. In another example, if a quick and small size model update is needed, network computing device 201 may enable a PHY layer model transfer with mini-slot. In yet another example, if a slow and small size model update is enough, network computing device 201 may enable an application layer model transfer.

In some embodiments, in the different phases, exchanging of the model and the outputs of the models can be via transferring the weights and biases of the model, or gradients of the model matrix.

Symbiotic federations will now be described.

In some embodiments, two symbiotic federations take place in parallel. For example, one between gNBs 201 and the other between UEs 205 as described further below

UEs 205 may upload to a gNB 201 their learned model 207 and quantized version of their output or a function of that output 209.

gNB 201 may aggregate the models 207 of UEs 205 and the quantized output (e.g., secondary carrier signal strength (RSP, RSRQ)) 209 of UEs 205.

gNB 201 may take (a) the aggregated quantized output, MSEs or R2s 211 of the UEs 205, and (b) other gNB 201 available measurements 303 such as network throughput load, interference and cell utilization to train a local model 301 at gNB 201.

The local model 301 trained at gNB 201 may be aggregated together with additional models 217 trained by other gNBs 213 in proximity by an additional controller network computing device 215 (e.g., a gNB controller). During the aggregation of that model, weighted federated averaging may be performed where the weights are balanced accordingly on the distribution of labels. In this case, a decision is aimed at deciding whether the UE 205 takes the final decision for, e.g. a SC handover or selection. The process repeats periodically.

In some embodiments, a trained model is moved to gNB 201 and may be used as described above after UEs 205 predict a parameter, for a decision on an operation in the network.

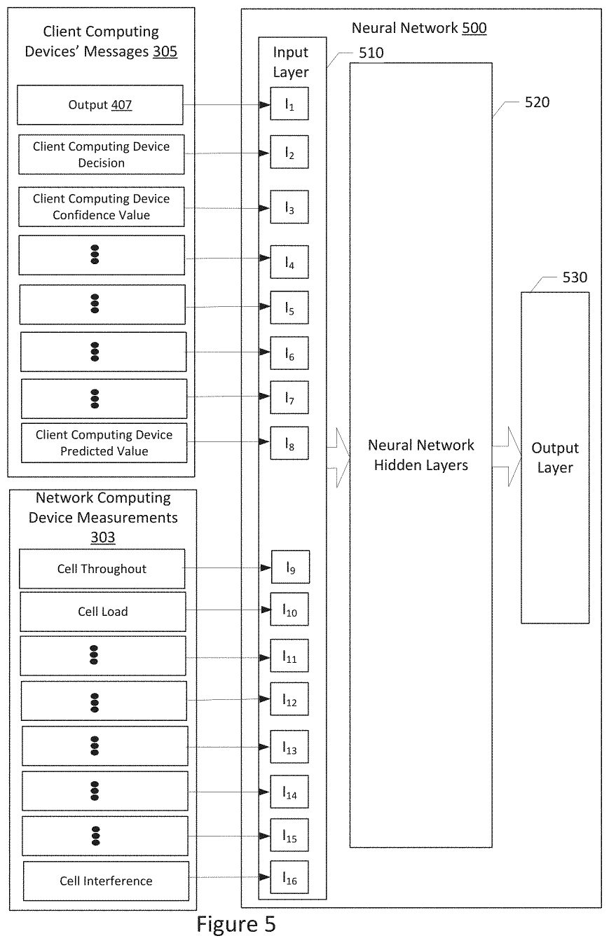

FIG. 5 illustrates elements of the neural network circuit which are interconnected and configured to operate in accordance with some embodiments of the present disclosure.

In the non-limiting illustrative embodiment of FIG. 5, a processing circuit of network computing device 201 operates the input nodes of the input layer 510 to each receive different client computing device messages 305 and network computing device measurements 303. Client computing devices' messages 305 may include, but are not limited to, output 407 of client machine learning model 401, client computing device 205 decision; client computing device 205 confidence value; client computing device 205 predicted value, etc. Network computing device measurements 303 may include, but are not limited to, cell throughput, cell load, cell interference, etc. Each of the input nodes multiply an input value that are input by a reward or loss value that is feedback to the input node to generate a weighted input value. When the input value exceeds a firing threshold assigned to the input node, the input node then provides the weighted input value to the combining nodes of the first one of the sequence of the hidden layers 520. The input node does not output the weighted input value if and until the weighted input value exceeds the assigned firing threshold

Although the embodiment of FIG. 5 shows a one-to-one mapping between each type of input 303, 305 and one input node of the input layer 510, other embodiments are not limited thereto. For example, in one embodiment, a plurality of different types of inputs can be combined to generate a combined input that is input to one input node of the input layer 510. Alternatively, or additionally, in a second embodiment, a plurality of inputs over time for a single type of input for, e.g., a cell and/or its neighboring cells can be combined to generate a combined input that is input to one input node of the input layer 510.

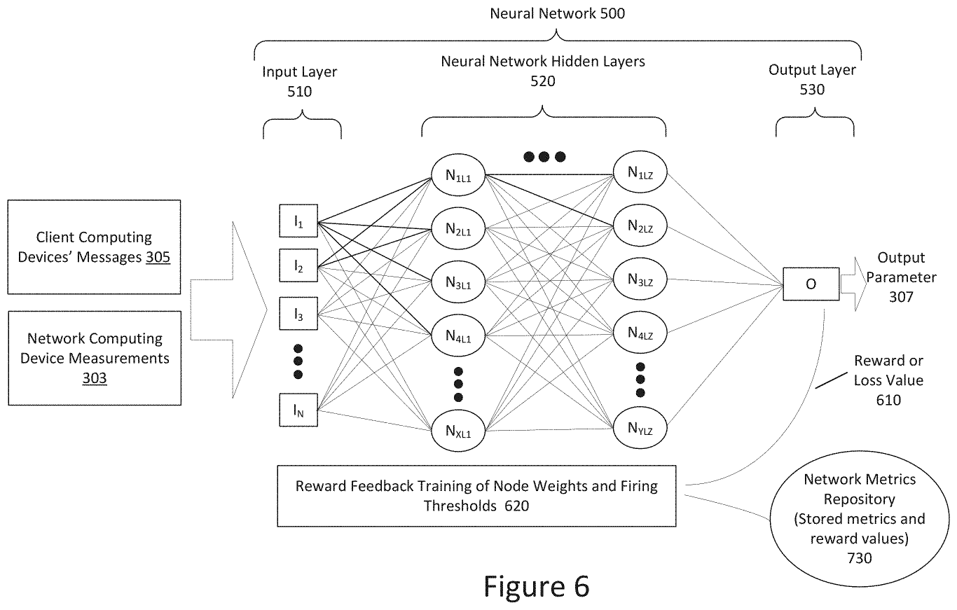

FIG. 6 is a block diagram and data flow diagram of a neural network circuit 500 that can be used, e.g., in the network computing device 201 to generate an output parameter 307 and perform feedback training 610 of the node weights and firing thresholds 620 of the input layer 510, the neural network hidden layers 520 and at least one output layer 530.

Referring to FIG. 6, the neural network circuit 500 includes the input layer 510 having a plurality of input nodes, the sequence of neural network hidden layers 520 each including a plurality of weight nodes, and at least one output layer 530 including an output node. In the particular non-limiting example of FIG. 6, the input layer 510 includes input nodes I₁ to I_{N} (where N is any plural integer). The inputs 303, 305 are provided to different ones of the input nodes I₁ to I_{N}. A first one of the sequence of neural network hidden layers 520 includes weight nodes N_{1L1} (where “1L1” refers to a first weight node on layer one) to N_{XL1} (where X is any plural integer). A last one (“Z”) of the sequence of neural network hidden layers 520 includes weight nodes N_{1LZ} (where Z is any plural integer) to N_{YLZ} (where Y is any plural integer). At least one output layer 530 includes an output node O.

The neural network circuit 500 of FIG. 6 is an example that has been provided for ease of illustration and explanation of one embodiment. Other embodiments may include any non-zero number of input layers having any non-zero number of input nodes, any non-zero number of neural network layers having a plural number of weight nodes, and any non-zero number of output layers having any non-zero number of output nodes. The number of input nodes can be selected based on the number of inputs 303, 305 that are to be simultaneously processed, and the number of output nodes can be similarly selected based on the number of output parameters 307 that are to be simultaneously generated therefrom.

The neural network circuit 500 can be operated to process different inputs 303, 305, during a training mode by a processing circuit of network computing device 201 and/or during the execution mode of the trained neural network circuit 500, through different inputs (e.g., input nodes I₁ to I_{N}) of the neural network circuit 500. Inputs 303, 305 that can be simultaneously processed through different input nodes I₁ to I_{N}.

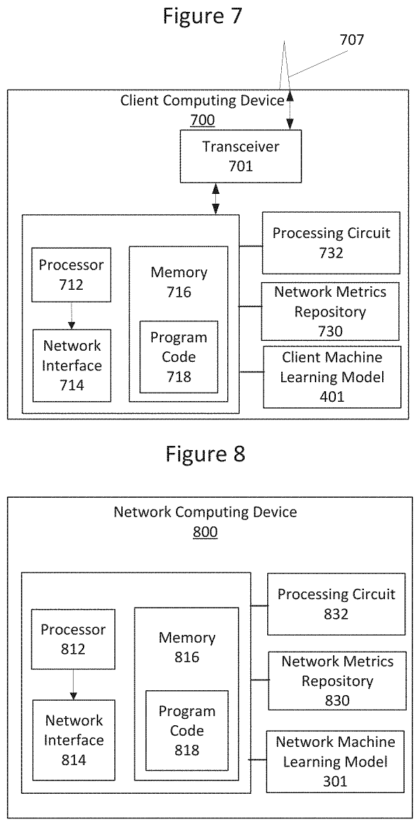

FIG. 7 is a block diagram illustrating a client computing device 700 (e.g., client computing device 205 of FIG. 2) according to some embodiments of inventive concepts. Client computing device 700 may be implemented using structure of FIG. 7 with instructions stored in device readable medium (also referred to as memory) 716 of client computing device 700 so that when instructions of memory 716 are executed by at least one processor (also referred to as processing circuitry) 732 of client computing device 700, at least one processor 732 performs respective operations discussed herein. Processing circuitry 732 of client computing device 700 may thus transmit and/or receive communications to/from one or more other network nodes/entities/servers of a telecommunications network through network interface 714 of client computing device 700. In addition, processing circuitry 732 of client computing device 700 may transmit and/or receive communications to/from one or more wireless devices through interface 714 of client computing device 700 (e.g., using transceiver 701). Client computing device 700 may further include client machine learning model 401 and a network metrics repository 730 storing metrics and reward values (if any) during operation of client machine learning model 401 as described below.

FIG. 8 is a block diagram illustrating a network computing device 800 (e.g., network computing device 201 of FIG. 2) according to some embodiments of inventive concepts. Network computing device 800 may be implemented using structure of FIG. 8 with instructions stored in device readable medium (also referred to as memory) 816 of client computing device 800 so that when instructions of memory 816 are executed by at least one processor (also referred to as processing circuitry) 832 of network computing device 800, at least one processor 832 performs respective operations discussed herein. Processing circuitry 832 of network computing device 800 may thus transmit and/or receive communications to/from one or more other network nodes/entities/servers/client computing devices of a telecommunications network through network interface 814 of network computing device 800. Network computing device 800 may further include network machine learning model 301 and a network metrics repository 830 storing metrics and reward values (if any) during operation of network machine learning model 301 as described above.

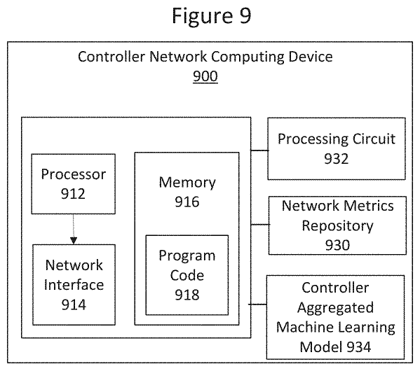

FIG. 9 is a block diagram illustrating a controller network computing device 900 (e.g., network computing device 215 of FIG. 2) according to some embodiments of inventive concepts. Controller network computing device 900 may be implemented using structure of FIG. 9 with instructions stored in device readable medium (also referred to as memory) 916 of client computing device 900 so that when instructions of memory 916 are executed by at least one processor (also referred to as processing circuitry) 932 of controller network computing device 900, at least one processor 932 performs respective operations discussed herein. Processing circuitry 932 of controller network computing device 900 may thus transmit and/or receive communications to/from one or more other network nodes/entities/servers/client computing devices of a telecommunications network through network interface 914 of controller network computing device 900. Controller network computing device 900 may further include controller aggregated machine learning model 934 and a network metrics repository 930 storing metrics and reward values (if any) during operation of controller aggregated machine learning model 934 as described below.

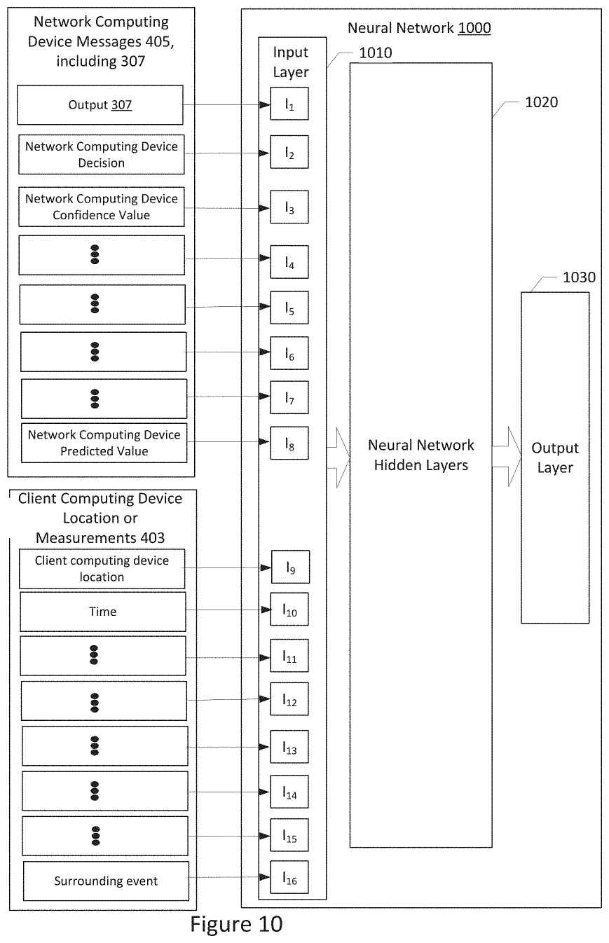

FIG. 10 illustrates elements of the neural network circuit which are interconnected and configured to operate in accordance with some embodiments of the present disclosure.

In the non-limiting illustrative embodiment of FIG. 10, a processing circuit of client computing device 700 (e.g., client computing device 201 of FIG. 2) operates the input nodes of the input layer 1010 to each receive different client computing device messages or location 403 and network computing device messages 405. Client computing devices' measurement and location 403 may include, but are not limited to, client computing device 700 location, time, surrounding event, etc. Network computing device messages 405 may include, but are not limited to, output 307 of network machine learning model 301, network computing device 800 decision, network computing device 800 confidence value, network computing device 800 predicted value, etc. Each of the input nodes multiply an input value that are input by a reward or loss value that is feedback to the input node to generate a weighted input value. When the input value exceeds a firing threshold assigned to the input node, the input node then provides the weighted input value to the combining nodes of the first one of the sequence of the hidden layers 1020. The input node does not output the weighted input value if and until the weighted input value exceeds the assigned firing threshold

Although the embodiment of FIG. 10 shows a one-to-one mapping between each type of input 403, 405 and one input node of the input layer 1010, other embodiments are not limited thereto. For example, in one embodiment, a plurality of different types of inputs can be combined to generate a combined input that is input to one input node of the input layer 1010. Alternatively, or additionally, in a second embodiment, a plurality of inputs over time for a single type of input for, e.g., a cell and/or its neighboring cells can be combined to generate a combined input that is input to one input node of the input layer 1010.

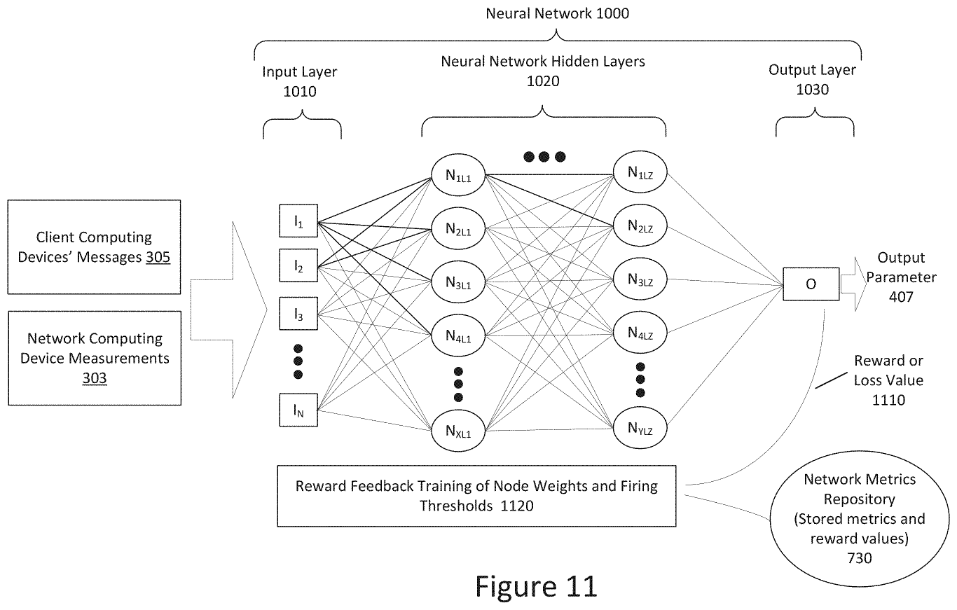

FIG. 11 is a block diagram and data flow diagram of a neural network circuit 1000 that can be used, e.g., in the client computing device 205 to generate an output parameter 407 and perform feedback training 1110 of the node weights and firing thresholds 1120 of the input layer 1010, the neural network hidden layers 1020 and at least one output layer 1030.

Referring to FIG. 11, the neural network circuit 1000 includes the input layer 1010 having a plurality of input nodes, the sequence of neural network hidden layers 1020 each including a plurality of weight nodes, and at least one output layer 1030 including an output node. In the particular non-limiting example of FIG. 11, the input layer 1010 includes input nodes I₁ to I_{N} (where N is any plural integer). The inputs 403, 405 are provided to different ones of the input nodes I₁ to I_{N}. A first one of the sequence of neural network hidden layers 1020 includes weight nodes N_{1L1} (where “1L1” refers to a first weight node on layer one) to N_{XL1} (where X is any plural integer). A last one (“Z”) of the sequence of neural network hidden layers 1020 includes weight nodes N_{1LZ} (where Z is any plural integer) to N_{YLZ} (where Y is any plural integer). At least one output layer 1030 includes an output node O.

The neural network circuit 1000 of FIG. 11 is an example that has been provided for ease of illustration and explanation of one embodiment. Other embodiments may include any non-zero number of input layers having any non-zero number of input nodes, any non-zero number of neural network layers having a plural number of weight nodes, and any non-zero number of output layers having any non-zero number of output nodes. The number of input nodes can be selected based on the number of inputs 403, 405 that are to be simultaneously processed, and the number of output nodes can be similarly selected based on the number of output parameters 407 that are to be simultaneously generated therefrom.

The neural network circuit 1000 can be operated to process different inputs 403, 405, during a training mode by a processing circuit of client computing device 700 and/or during the execution mode of the trained neural network circuit 1000, through different inputs (e.g., input nodes I₁ to I_{N}) of the neural network circuit 1000. Inputs 403, 405 that can be simultaneously processed through different input nodes I₁ to I_{N}.

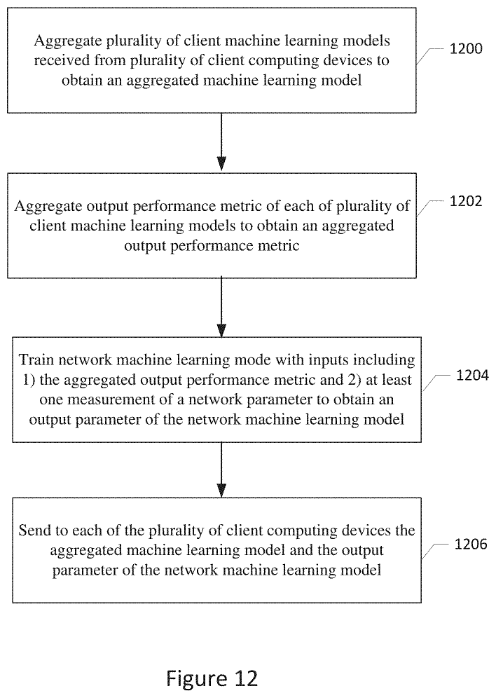

These and other related operations will now be described in the context of the operational flowcharts of FIGS. 12-26 of operations that may be performed by a network computing device 800 (e.g., network computing device 201 of FIG. 2) according to various embodiments of inventive concepts. Each of the operations described in FIGS. 12-26 can be combined and/or omitted in any combination with each other, and it is contemplated that all such combinations fall within the spirit and scope of this disclosure.

Referring initially to FIG. 12, operations can be performed by a network computing device (e.g., 800 implemented using the structure of the block diagram of FIG. 8) in a telecommunications network 200 for adaptively deploying an aggregated machine learning model (e.g., 203) and an output parameter (e.g., 307) in the telecommunications network to control an operation in the telecommunications network. The operations of network computing device 800 include aggregating (1200) a plurality of client machine learning models (e.g., 207) received from a plurality of client computing devices (e.g., 205, 700) in the telecommunications network to obtain an aggregated machine learning model (e.g., 203). The operations of network computing device 800 further include aggregating (1202) an output performance metric (e.g., 209) of the plurality of the client machine learning models (e.g., 207) received from the plurality of client computing devices (e.g., 205) to obtain an aggregated output performance metric (e.g., 211). The operations of network computing device 800 further include training (1204) a network machine learning model (e.g., 301) with inputs comprising 1) the aggregated output performance metric (e.g., 211) and 2) at least one measurement of a network parameter (303) to obtain an output parameter (e.g., 307) of the network machine learning model. The operations of network computing device 800 further include sending (1206) to the plurality of client computing devices (e.g., 205) the aggregated machine learning model (e.g., 203) and the output parameter (e.g., 307) of the network machine learning model.

In some embodiments, the output performance metric (e.g., 209) of the plurality of the client machine learning models includes at least one of: a predicted quantized output; a predicted function of a quantized output; a decision on the operation in the telecommunications network; a gradient of a variation between a common type of the output of a client computing device and the network computing device; and a loss value indicting and accuracy of at least one of the plurality of client machine learning model.

In some embodiments, the network machine learning model (e.g., 301) includes a neural network (e.g., 500).

In some embodiments, the at least one measurement of network parameter (e.g., 303) includes at least one measurement of a parameter of a cell of the telecommunications network.

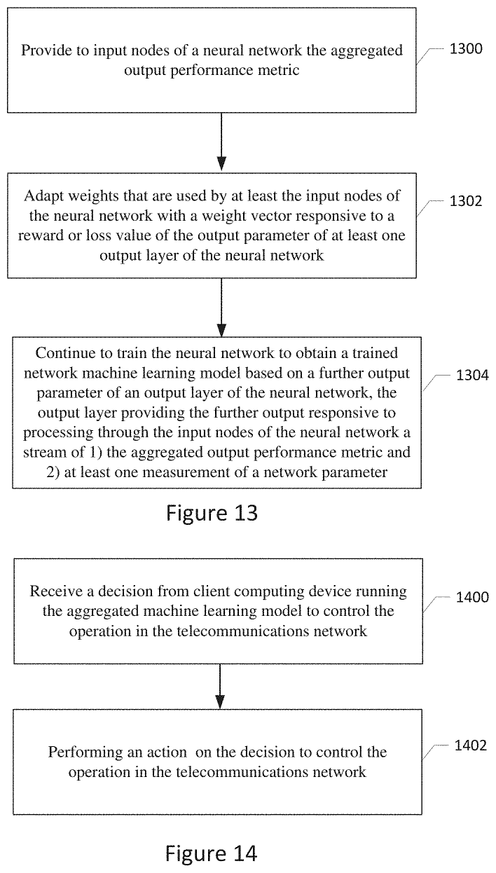

Referring to FIGS. 12 and 13, further operations that can be performed by the network computing device 800 may include the training (1204) the network machine learning model with the inputs including 1) the aggregated output performance metric (e.g., 211) and 2) at least one measurement of a network parameter (e.g., 303) to obtain the output parameter (e.g., 307) of the network machine learning model includes providing (1300) to input nodes (e.g., 510) of a neural network (e.g., 500) the aggregated output performance metric (e.g., 211). The training (1204) may further include adapting (1302) weights that are used by at least the input nodes (e.g., 510) of the neural network with a weight vector responsive to a reward value or a loss value (e.g., 610) of the output parameter (e.g., 307) of at least one output layer (e.g., 530) of the neural network. The training (1204) may further include continuing (1304) to perform the training of the neural network to obtain a trained network machine learning model (e.g., 301) based on a further output parameter (e.g., 307) of the at least one output layer (e.g., 530) of the neural network, the at least one output layer (e.g., 530) providing the further output responsive to processing through the input nodes (e.g., 510) of the neural network a stream of 1) the aggregated output performance metric (e.g., 211) and 2) at least one measurement of the network parameter (e.g., 303).

Referring to FIG. 14, further operations that can be performed by a network computing device 800 may include receiving (1400) a decision from a client computing device running the aggregated machine learning model (e.g., 203) to control the operation in the telecommunications network. Further operations that may be performed by the network computing device 800 may include performing an action (1402) on the decision to control the operation in the telecommunications network.

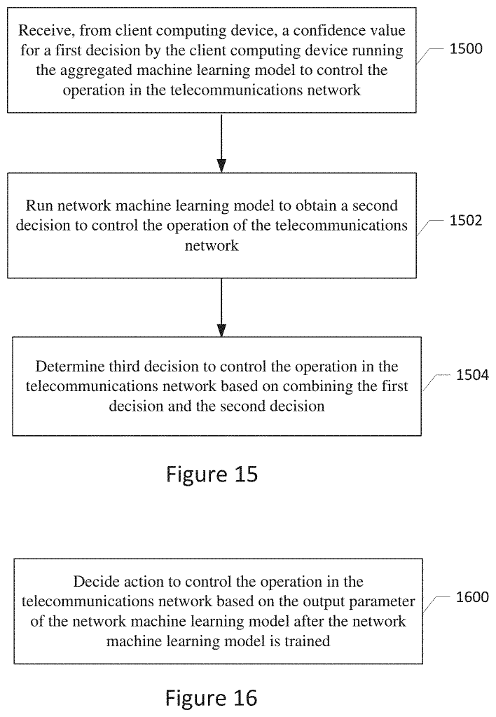

Referring to FIG. 15, further operations that can be performed by a network computing device 800 may include receiving (1500), from a client computing device (e.g., 205), a confidence value for a first decision by the client computing device running the aggregated machine learning model to control the operation in the telecommunications network. Further operations may include running (1502) the network machine learning model (e.g., 301) to obtain a second decision to control the operation of the telecommunications network. Further operations that may be performed by the network computing device 800 may include determining (1504) a third decision to control the operation in the telecommunications network based on combining the first decision and the second decision.

Referring to FIG. 16, further operations that can be performed by a network computing device 800 may include deciding (1600) an action to control the operation in the telecommunications network based on the output parameter (e.g., 307) of the network machine learning model after the network machine learning model is trained.

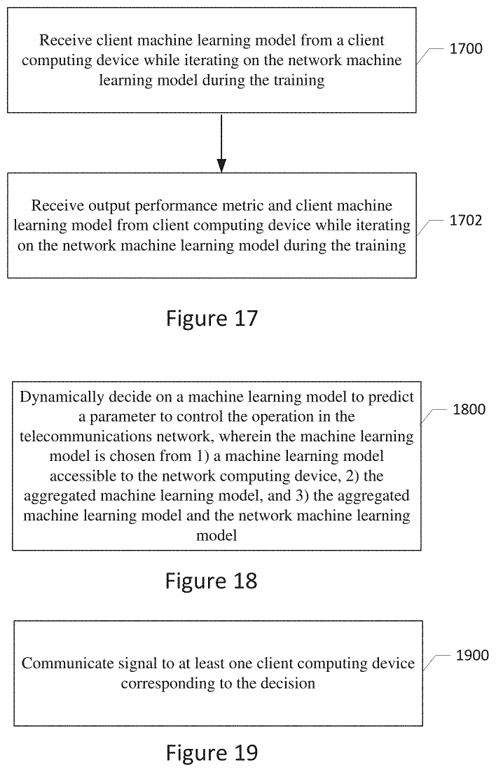

Referring to FIG. 17, further operations that can be performed by a network computing device 800 may include at least one of: receiving (1700) at least one of the plurality of client machine learning models (e.g., 207) from a client computing device while iterating on the network machine learning model during the training; and receiving (1702) the output performance metric (e.g., 209) and at least one of the plurality of client machine learning models (e.g., 207) from the client computing device (e.g., 205) while iterating on the network machine learning model during the training.

Referring again to FIG. 12, in some embodiments, the sending (1206) to the plurality of client computing devices (e.g., 205) the aggregated machine learning model (e.g., 203) and the output parameter (e.g., 307) of the network machine learning model mat include at least one of: sending the aggregated machine learning model (e.g., 203) to the plurality of client computing devices while iterating on the network machine learning model during the training; and sending the output parameter (e.g., 307) of the network machine learning model (e.g., 301) and the aggregated machine learning model (e.g., 203) to the plurality of client computing devices while iterating on the network machine learning model during the training.

In some embodiments, the aggregated output performance metric (211) further includes adapting the aggregated output performance metric to a number of client computing devices (e.g., 205, 700) that report the output performance metric (e.g., 209) to the network computing device (e.g., 201) based on one of: a weighted average of the output performance metric of the plurality of the client machine learning models; a statistical combination of the output performance metric of the plurality of the client machine learning models; and a minimum and a maximum of the output performance metric of the plurality of the client machine learning models.

Referring to FIG. 18, further operations that can be performed by a network computing device 800 may include dynamically deciding (1800) on a machine learning model to predict an output parameter to control the operation in the telecommunications network, wherein the machine learning model is chosen from 1) a machine learning model accessible to the network computing device, 2) the aggregated machine learning model, and 3) the aggregated machine learning model and the network machine learning model.

In some embodiments, the dynamically deciding (1800) on a machine learning model is a decision based on at least one change in a network parameter of the telecommunications network and one of: 1) local information of at least one of the plurality of client computing devices (e.g., 205, 700) used to predict the parameter, 2) a measurement by the network computing device (e.g., 201) of at least one change in the network parameter used to predict the parameter; and 3) both the local information of at least one of the plurality of client computing devices and the measurement by the network computing device of at least one change in the network parameter used to predict the parameter.

Referring to FIG. 19, in some embodiments, further operations that can be performed by a network computing device 800 include communicating (1900) a signal to at least one client computing device (e.g., 205, 700) corresponding to the decision.

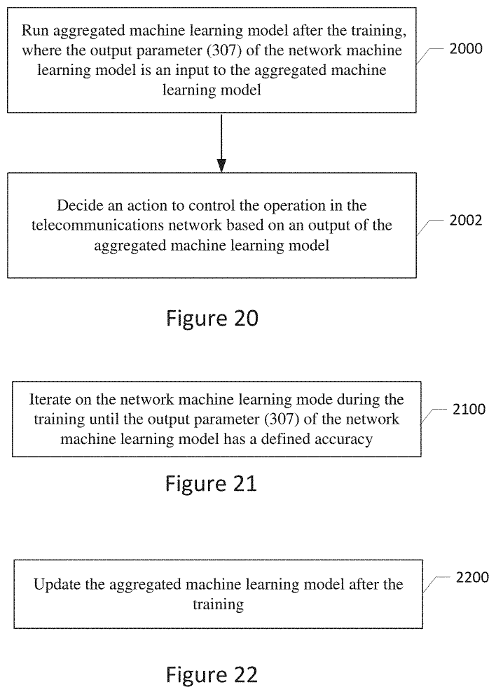

Referring to FIG. 20, in some embodiments, further operations that can be performed by a network computing device 800 include running (2000) the aggregated machine learning model (e.g., 203) after the training where the output parameter (e.g., 307) of the network machine learning model is an input to the aggregated machine learning model. Further operations that can be performed by a network computing device 800 include deciding (2002) an action to control the operation in the telecommunications network based on an output of the aggregated machine learning model.

Referring to FIG. 21, in some embodiments, further operations that can be performed by a network computing device 800 include iterating (2100) on the network machine learning model (e.g., 301) during the training until the output parameter (e.g., 307) of the network machine learning model has a defined accuracy.

In some embodiments, the output parameter (e.g., 307) of the network machine learning model inlcludes at least one of: an aggregated weight of the aggregated machine learning model; a gradient of a variation between the output performance metric and the output parameter over a defined time period; and a loss metric indicating an accuracy of the network machine learning model.

Referring to FIG. 22, in some embodiments, further operations that can be performed by a network computing device 800 include updating (2200) the aggregated machine learning model (e.g., 203) after the training. The updating is performed based on one of: an environmental change in the telecommunications network; an event in a neighboring cell of the telecommunications network; a fluctuation in a channel of the telecommunications network; a fluctuation in a load of a target cell and a neighbor cell, respectively; and an event in the telecommunications network.

In some embodiments, the updating the aggregated machine learning model (e.g., 203) after the training is sent to at least one of the plurality of the client computing devices based on one of based on one of:

enabling a physical layer, PHY layer, a medium access control layer, MAC layer, a resource radio control layer, RRC layer, a packet data convergence protocol layer, PDCP layer, and an application layer for sending the aggregated machine learning model to the plurality of client computing devices;

enabling a PHY layer with a mini slot for sending the aggregated machine learning model to the plurality of client computing devices; and

enabling an application layer for sending the aggregated machine learning model to the plurality of client computing devices.

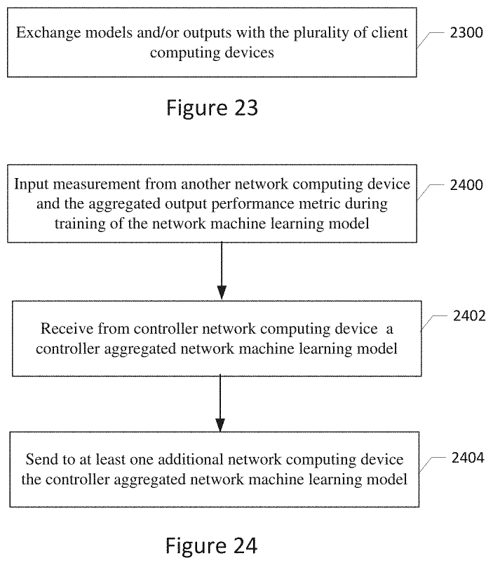

Referring to FIG. 23, in some embodiments, further operations that can be performed by a network computing device 800 include exchanging (2300) models and/or outputs with the plurality of client computing devices. The exchanging includes receiving the plurality of client machine learning models (e.g., 207) from the plurality of client computing devices. The plurality of client machine learning models received from the plurality of client computing devices and the sending to the plurality of client computing devices the aggregated machine learning model includes the receiving and/or the sending, respectively, performed via a first message received and/or sent using one of a signal type as follows: a resource radio control, RRC, configuration signal; a physical downlink control channel, PDCCH, signal from the network computing device; a physical uplink control channel, PUCCH, signal from at least one client computing device; and a medium access control, MAC, control element signal.

Referring to FIG. 23, in some embodiments, the exchanging (2300) models and/or outputs of models with the plurality of client computing devices (e.g., 205, 700) includes receiving the output performance metric of the plurality of the client machine learning models received from the plurality of client computing devices. The receiving the output performance metric of the plurality of the client machine learning models from the plurality of client computing devices and the sending to the plurality of client computing devices the output parameter of the network machine learning machine is performed via a second message received and/or sent using one of as follows: a resource radio control, RRC, configuration signal; a physical downlink control channel, PDCCH, signal from the network computing device; a physical uplink control channel, PUCCH, signal from at least one client computing device; and a medium access control, MAC, control element signal.

Still referring to FIG. 23, in some embodiments, the network computing device 800 determines the signal type for the exchanging based on at least one of: a convergence speed of the aggregated machine learning model; a convergence speed of the network machine learning model; an indication of a dynamicity of a wireless channel for the receiving and/or sending of the first message and/or the second message; a defined accuracy of the aggregated machine learning model; a defined accuracy of the network machine learning model; a change in mobility of at least one of the plurality of client computing devices; and at least one change in speed of a network parameter of the telecommunications network.

In some embodiments, the network computing device 800 determines the signal type for each of the receiving and/or sending and a frequency of the exchanging based on at least one of a target rate that the at least one of the plurality of client computing devices sets for reaching a convergence for the aggregated machine learning model; and a rate of change of the at least one change in a speed of the network parameter of the telecommunications network.

Still referring to FIG. 23, in some embodiments, the exchanging further includes one or more of: sending weights and biases of the aggregated machine learning model to the plurality of client computing devices; receiving a transfer of weights and biases from the plurality of client machine learning models from the plurality of client computing devices; sending one or more gradients of a matrix of the aggregated machine learning model to the plurality of client computing devices; and receiving one or more gradients of a matrix of at least one client machine learning model from the plurality of client machine learning models from at least one of the plurality of client computing devices.

Referring to FIG. 24, in some embodiments, further operations that can be performed by a network computing device 800 include inputting (2400) a measurement from another network computing device (e.g., 213, 800) and the aggregated output performance metric (e.g., 211) during the training of the network machine learning model (e.g., 301). Further operations that can be performed by a network computing device 800 include receiving (2402) from a controller network computing device (e.g., 215, 900) a controller aggregated network machine learning model (e.g., 934). The controller aggregated network machine learning model (e.g., 934) may include the network machine learning model (e.g., 301) aggregated with at least one additional machine learning model (e.g., 217, 301) trained by at least one additional network computing device (e.g., 213). Further operations that can be performed by a network computing device 800 include sending (2404) to the at least one additional network computing device (e.g., 205) the controller aggregated network machine learning model (e.g., 934).

In some embodiments, the network computing device (e.g., 201, 800) is a network node and the plurality of client computing devices includes a communication device.

In some embodiments, the output performance metric (e.g., 209) is a predicted secondary carrier signal strength.

In some embodiments, the operation in the telecommunications network includes a secondary carrier operation.

According to some embodiments, a computer program can be provided that includes instructions which, when executed on at least one processor, cause the at least one processor to carry out methods performed by the network computing device.

According to some embodiments, a computer program product can be provided that includes a non-transitory computer readable medium storing instructions that, when executed on at least one processor, cause the at least one processor to carry out methods performed by the network computing device.

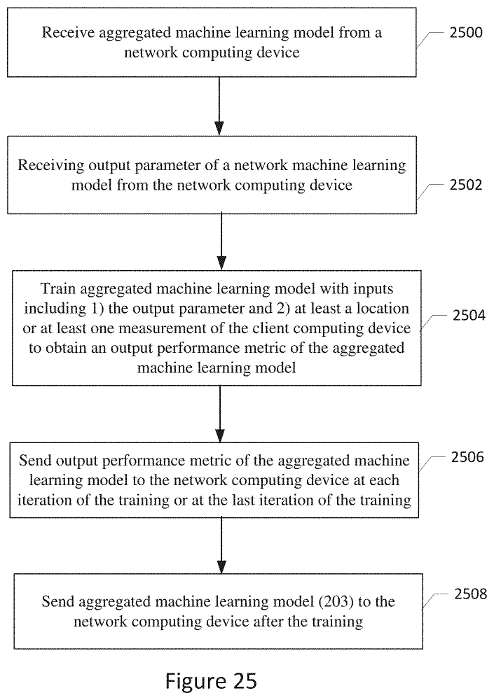

Operations of a client computing device 700 (implemented using the structure of the block diagram of FIG. 7) will now be discussed with reference to the flow charts of FIGS. 25-32 according to some embodiments of inventive concepts. Each of the operations described in FIGS. 25-32 can be combined and/or omitted in any combination with each other, and it is contemplated that all such combinations fall within the spirit and scope of this disclosure.

Referring initially to FIG. 25, operations can be performed by a client computing device 700 (e.g., 205) of a telecommunications network (e.g., 200) to control an operation in the telecommunications network. The operations include receiving (2500) an aggregated machine learning model (e.g., 203) from a network computing device (e.g., 201, 800). The operations further include receiving (2502) an output parameter (e.g., 307) of a network machine learning model (e.g., 301) from the network computing device (e.g., 201, 800). The operations further include training (2504) the aggregated machine learning model (e.g., 203) in iterations with inputs. The inputs include 1) the output parameter (e.g., 307) and 2) at least a location or at least one measurement of the client computing device (e.g., 403) to obtain an output performance metric (407) of the aggregated machine learning model. The operations further include sending (2506) the output performance metric (e.g., 407) of the aggregated machine learning model (e.g., 203) to the network computing device at each iteration of the training or at the last iteration of the training.

Still referring to FIG. 25, in some embodiments, further operations that can be performed by a client computing device 700 include sending (2508) the aggregated machine learning model (e.g., 203) to the network computing device (e.g., 201, 800) at each iteration of the training or at the last iteration of the training.

In some embodiments, the output performance metric (e.g., 209) of the client machine learning model (e.g., 207) includes at least one of: a predicted quantized output; a predicted function of a quantized output; a decision on the operation in the telecommunications network; a gradient of a variation between a common type of the output of a client computing device and the network computing device; and a loss value indicting and accuracy of a client machine learning model.

In some embodiments, the aggregated machine learning model (e.g., 203) comprises a neural network (e.g., 1000).

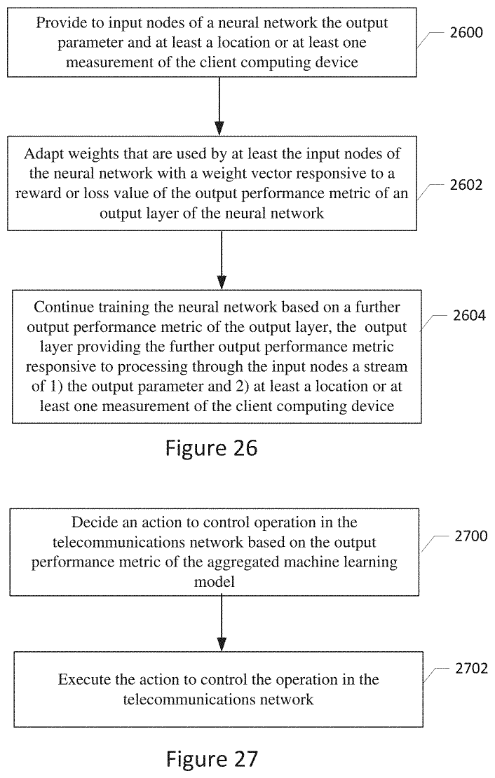

Referring to FIGS. 25 and 26, in some embodiments, further operations that can be performed by a client computing device 700 include for the training (2504) include providing (2600) to input nodes (e.g., 1010) of a neural network (e.g., 1000) 1) the output parameter (e.g., 307) and 2) at least a location or at least one measurement of the client computing device (e.g., 403). Further operations include adapting (2602) weights that are used by at least the input nodes (e.g., 1010) of the neural network with a weight vector responsive to a reward value or a loss value (e.g., 1110) of the output performance metric (e.g., 407) of at least one output layer (e.g., 1030) of the neural network. Further operations include continuing (2604) the training of the neural network based on a further output performance metric (e.g., 407) of the at least one output layer (e.g., 1030) of the neural network, the at least one output layer (e.g., 1030) providing the further output performance metric (e.g., 407) responsive to processing through the input nodes (e.g., 1010) of the neural network a stream of 1) the output parameter (e.g., 307) and 2) at least a location or at least one measurement of the client computing device (e.g., 403) to obtain the output performance metric (e.g., 407) of the client machine learning model.

Referring to FIG. 27, in some embodiments, further operations that can be performed by a client computing device 700 include deciding (2700) an action to control the operation in the telecommunications network based on the output performance metric (e.g., 407) of the aggregated machine learning model (203). Further operations include executing (2702) the action to control the operation in the telecommunications network.

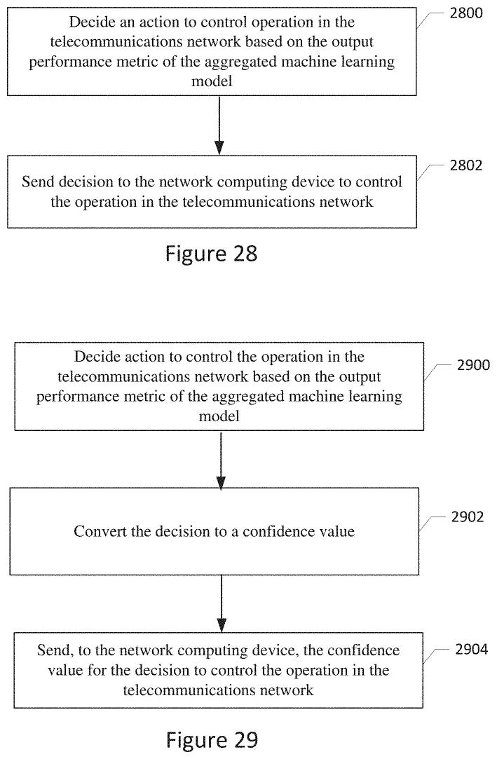

Referring to FIG. 28, in some embodiments, further operations that can be performed by a client computing device 700 include deciding (2800) an action to control the operation in the telecommunications network based on the output performance metric (e.g., 407) of the aggregated machine learning model (e.g., 203). Further operations include sending (2802) the decision to the network computing device (e.g., 201, 800) to control the operation in the telecommunications network.

Referring to FIG. 29, in some embodiments, further operations that can be performed by a client computing device 700 include deciding (2900) an action to control the operation in the telecommunications network based on the output performance metric (e.g., 407) of the aggregated machine learning model (e.g., 203). Further operations include converting (2902) the decision to a confidence value. Further operations include sending (2904), to the network computing device, the confidence value for the decision to control the operation in the telecommunications network.

Referring to FIG. 25, in some embodiments, the sending (2506) the output performance metric (e.g., 407) of the aggregated machine learning model (e.g., 203) to the network computing device at each iteration of the training or at the last iteration of the training is sent to the network computing device to decide the action to control the operation in the telecommunications network.

In some embodiments, the output parameter (e.g., 307) of the network machine learning model includes at least one of: an aggregated weight of the aggregated machine learning model; a gradient of a variation between the output performance metric and the output parameter over a defined time period; and a loss metric indicating an accuracy of the network machine learning model.

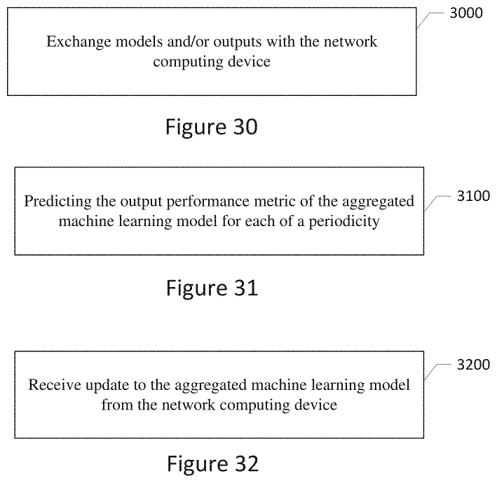

Referring to FIG. 30, in some embodiments, further operations that can be performed by a client computing device 700 include exchanging (3000) models and/or outputs with the network computing device. The exchanging includes an exchange of one or more of:

the receiving an aggregated machine learning model (e.g., 203) from a network computing device (e.g., 201, 800); the receiving the output parameter (e.g., 307) of a network machine learning model (301) from the network computing device (e.g., 201, 800); the sending an output performance metric (e.g., 407) of the aggregated machine learning model (e.g., 203) to the network computing device; and the sending the aggregated machine learning model (e.g., 203) to the network computing device (e.g., 201, 800). The exchange is performed via a message received and/or sent using one of a signal type as follows: a resource radio control, RRC, configuration signal; a physical downlink control channel, PDCCH, signal from the network computing device; a physical uplink control channel, PUCCH, signal from at least one client computing device; and a medium access control, MAC, control element signal.

In some embodiments, the exchanging (3000) further includes one or more of: sending weights and biases of the aggregated machine learning model (e.g., 203) to the network computing device; receiving a transfer of weights and biases of the aggregated machine learning model (e.g., 203) from the network computing device; sending gradients of a matrix of the aggregated machine learning model (e.g., 203) to the network computing device; and receiving gradients of a matrix of the aggregated machine learning model (e.g., 203) from the network computing device.

Referring to FIG. 31, in some embodiments, further operations that can be performed by a client computing device 700 include predicting (3100) the output performance metric (e.g., 407) of the aggregated machine learning model (e.g., 203) for each of a periodicity. The periodicity varies based on at least one of: a dynamicity of at least one change in the telecommunications network; a location of the client computing device; and a target rate that the client computing device sets for reaching a convergence for the aggregated machine learning model (203).

In some embodiments, the at least a location or at least one measurement of the client computing device (e.g., 403) to obtain an output performance metric (e.g., 407) of the aggregated machine learning model includes one or more of: a location of the client computing device; a time at the location of the client computing device; and an event in the telecommunications network.

Referring to FIG. 32, in some embodiments, further operations that can be performed by a client computing device 700 include receiving (3200) an update to the aggregated machine learning model (e.g., 203) from the network computing device.

In some embodiments, the client computing device (e.g., 205, 700) is a communication device and the network computing device (e.g., 201, 800) is a network node.

In some embodiments, the output performance metric (e.g., 407) includes at least one of: a predicted secondary carrier signal strength; and a decision on a secondary carrier operation.

In some embodiments, the operation in the telecommunications network includes a secondary carrier operation.

According to some embodiments, a computer program can be provided that includes instructions which, when executed on at least one processor, cause the at least one processor to carry out methods performed by the client computing device.

According to some embodiments, a computer program product can be provided that includes a non-transitory computer readable medium storing instructions that, when executed on at least one processor, cause the at least one processor to carry out methods performed by the client computing device.

Aspects of the present disclosure have been described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the embodiments below are intended to include any disclosed structure, material, or act for performing the function in combination with other embodiments. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Exemplary embodiments are provided below. Reference numbers/letters are provided in parenthesis by way of example/illustration without limiting example embodiments to particular elements indicated by reference numbers/letters.

1. A method performed by a network computing device in a telecommunications network for adaptively deploying an aggregated machine learning model and an output parameter in the telecommunications network to control an operation in the telecommunications network, the method comprising:
aggregating a plurality of client machine learning models received from a plurality of client computing devices in the telecommunications network to obtain an aggregated machine learning model;
aggregating an output performance metric of the plurality of the client machine learning models received from the plurality of client computing devices to obtain an aggregated output performance metric;
training a network machine learning model with inputs comprising 1) the aggregated output performance metric and 2) at least one measurement of a network parameter to obtain an output parameter of the network machine learning model; and
sending to the plurality of client computing devices the aggregated machine learning model and the output parameter of the network machine learning model.

2. The method of claim 1, wherein the output performance metric of the plurality of the client machine learning models comprises at least one of:
a predicted quantized output;
a predicted function of a quantized output;
a decision on the operation in the telecommunications network;
a gradient of a variation between a common type of the output of a client computing device and the network computing device; and
a loss value indicting and accuracy of at least one of the plurality of client machine learning model.

3. The method of claim 1, wherein the network machine learning model comprises a neural network.

4. The method of claim 1, wherein the at least one measurement of network parameter comprises at least one measurement of a parameter of a cell of the telecommunications network.

5. The method of claim 3, wherein the training the network machine learning model with the inputs comprising 1) the aggregated output performance metric and 2) at least one measurement of a network parameter to obtain the output parameter of the network machine learning model comprises:
providing to input nodes of a neural network the aggregated output performance metric;
adapting weights that are used by at least the input nodes of the neural network with a weight vector responsive to a reward value or a loss value of the output parameter of at least one output layer of the neural network; and
continuing to perform the training of the neural network to obtain a trained network machine learning model based on a further output parameter of the at least one output layer of the neural network, the at least one output layer providing the further output responsive to processing through the input nodes of the neural network a stream of 1) the aggregated output performance metric and 2) at least one measurement of the network parameter.

6. The method of claim 1, further comprising:
receiving a decision from a client computing device running the aggregated machine learning model to control the operation in the telecommunications network; and
performing an action on the decision to control the operation in the telecommunications network.

7. The method of claim 1, further comprising:
receiving, from a client computing device, a confidence value for a first decision by the client computing device running the aggregated machine learning model to control the operation in the telecommunications network;
running the network machine learning model to obtain a second decision to control the operation of the telecommunications network; and
determining a third decision to control the operation in the telecommunications network based on combining the first decision and the second decision.

8. The method of claim 1, further comprising:
deciding an action to control the operation in the telecommunications network based on the output parameter of the network machine learning model after the network machine learning model is trained.

9. The method of claim 1, further comprising at least one of:
receiving at least one of the plurality of client machine learning models from a client computing device while iterating on the network machine learning model during the training; and
receiving at least one of the output performance metric and at least one of the plurality of client machine learning models from the client computing device while iterating on the network machine learning model during the training.

10. The method of claim 1, wherein the sending to the plurality of client computing devices the aggregated machine learning model and the output parameter of the network machine learning model comprises at least one of:
sending the aggregated machine learning model to the plurality of client computing devices while iterating on the network machine learning model during the training; and
sending the output parameter of the network machine learning model and the aggregated machine learning model to the plurality of client computing devices while iterating on the network machine learning model during the training.

11. The method of any claim 1, wherein the aggregated output performance metric further comprises adapting the aggregated output performance metric to a number of client computing devices that report the output performance metric to the network computing device based on one of:
a weighted average of the output performance metric of the plurality of the client machine learning models;
a statistical combination of the output performance metric of the plurality of the client machine learning models; and
a minimum and a maximum of the output performance metric of the plurality of the client machine learning models.

12. The method of claim 1, further comprising:
dynamically deciding on a machine learning model to predict an output parameter to control the operation in the telecommunications network, wherein the machine learning model is chosen from 1) a machine learning model accessible to the network computing device, 2) the aggregated machine learning model, and 3) the aggregated machine learning model and the network machine learning model.

13. The method of claim 12, wherein the dynamically deciding on a machine learning model comprises a decision based on at least one change in a network parameter of the telecommunications network and one of: 1) local information of at least one of the plurality of client computing devices is used to predict the parameter, 2) a measurement by the network computing device of at least one change in the network parameter is used to predict the parameter; and 3) both the local information of at least one of the plurality of client computing devices and the measurement by the network computing device of at least one change in the network parameter is used to predict the parameter.

14. The method of claim 13, further comprising:
communicating a signal to at least one client computing device corresponding to the decision.

15. The method of claim 1, further comprising:
running the aggregated machine learning model after the training, wherein the output parameter of the network machine learning model is an input to the aggregated machine learning model; and
deciding an action to control the operation in the telecommunications network based on an output of the aggregated machine learning model.

16. The method of claim 1, further comprising:
iterating on the network machine learning model (301) during the training until the output parameter of the network machine learning model has a defined accuracy.

17. The method of claim 1, wherein the output parameter of the network machine learning model comprises at least one of:
an aggregated weight of the aggregated machine learning model;
a gradient of a variation between the output performance metric and the output parameter over a defined time period; and
a loss metric indicating an accuracy of the network machine learning model.

18. The method of claim 1, further comprising:
updating the aggregated machine learning model after the training, wherein the updating is performed based on one of:
an environmental change in the telecommunications network;
an event in a neighboring cell of the telecommunications network;
a fluctuation in a channel of the telecommunications network;
a fluctuation in a load of a target cell and a neighbor cell, respectively; and
an event in the telecommunications network.

19. The method of claim 18, wherein the updating the aggregated machine learning model after the training is sent to at least one of the plurality of the client computing devices based on one of based on one of:
enabling a physical layer, PHY layer, a medium access control layer, MAC layer, a resource radio control layer, RRC layer, a packet data convergence protocol layer, PDCP layer, and an application layer for sending the aggregated machine learning model to the plurality of client computing devices;
enabling a PHY layer with a mini slot for sending the aggregated machine learning model to the plurality of client computing devices; and
enabling an application layer for sending the aggregated machine learning model to the plurality of client computing devices.

20. The method of claim 1, further comprising:
exchanging models and/or outputs with the plurality of client computing devices, wherein the exchanging comprises:
receiving the plurality of client machine learning models from the plurality of client computing devices; and
wherein the plurality of client machine learning models received from the plurality of client computing devices and the sending to the plurality of client computing devices the aggregated machine learning model comprises the receiving and/or the sending, respectively, performed via a first message received and/or sent using one of a signal type as follows:
a resource radio control, RRC, configuration signal;
a physical downlink control channel, PDCCH, signal from the network computing device;
a physical uplink control channel, PUCCH, signal from at least one client computing device; and
a medium access control, MAC, control element signal.

21.-62. (canceled)
